(19) United States
(12) Patent Application Publication
(10) Pub. No.: US 2026/0046694 A1
(43) Pub. Date: Feb. 12, 2026

(54) OFFLOADING PLAN ENABLED EXCHANGE BETWEEN NETWORK NODES

(71) Applicant: Nokia Technologies Oy, Espoo (FI)

(72) Inventors: Ethiraj ALWAR, Bangalore (IN); Anna PANTELIDOU, Antony (FR)

(21) Appl. No.: 18/998,728

(22) PCT Filed: Jul. 18, 2023
(86) PCT No.: PCT/EP2023/069854

§ 371 Date: Jan. 27, 2025

(30) Foreign Application Priority Data
Aug. 4, 2022 (IN) 202241044572

(51) Int. Cl. H04W 28/086

(52) U.S. Cl. CPC H04W 28/0861

(57) ABSTRACT

A method may include determining, by a first network node, a need for offloading at the first network node. A first request may be transmitted to a second network node for a cost metric associated with one or more user equipment connected to the first network node that is to be offloaded. The cost metric may be received along with a list of the one or more user equipment. A second request may be transmitted and the list of the one or more user equipment to a third network node for a predicted cost metric associated with the one or more user equipment in the list. The predicted cost metric may be received in response to the second request. Offloading of the one or more user equipment in the list may be offloaded to the second or third network node based on whichever node has the lowest cost metric.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for offloading plan enabled exchange between network nodes.

### BACKGROUND

Examples of mobile or wireless telecommunication systems may include the Universal Mobile Telecommunications System (UMTS), Long Term Evolution (LTE), LTE-Advanced (LTE-A), LTE-A Pro, and/or fifth generation (5G) or New Radio (NR) telecommunications systems, and future generation of telecommunications systems. Fifth generation (5G) telecommunications systems refer to the next generation (NG) of radio access networks and network architectures for core networks. A 5G telecommunication system is mostly based on new radio (NR) radio access technology (5G NR), but a 5G (or NG) network can also build on E-UTRAN. It is estimated that 5G NR will provide bitrates on the order of 10-20 Gbit/s or higher, and will support at least enhanced mobile broadband (eMBB) and ultra-reliable low-latency communication (URLLC) as well as massive machine-type communication (mMTC). 5G NR is expected to deliver extreme broadband and ultra-robust, low-latency connectivity and massive networking to support the Internet of Things (IoT).

### SUMMARY

Some example embodiments may be directed to a method. The method may include determining, by a first network node, a need for offloading at the first network node. The method may also include transmitting a first request to a second network node for a cost metric associated with one or more user equipment connected to the first network node that is to be offloaded. The method may further include receiving the cost metric along with a list of the one or more user equipment associated with the cost metric. In addition, the method may include transmitting a second request and the list of the one or more user equipment to a third network node for a predicted cost metric associated with the one or more user equipment in the list when connected to the third network node. In addition, the method may include receiving the predicted cost metric in response to the second request. The method may also include initiating offloading of the one or more user equipment in the list to the second or third network node based on whichever node has the lowest cost metric.

Other example embodiments may be directed to an apparatus. The apparatus may include at least one processor and at least one memory including computer program code. The at least one memory and computer program code may also be configured to, with the at least one processor, cause the apparatus at least to determine a need for offloading at the apparatus. The apparatus may also be caused to transmit a first request to a first network node for a cost metric associated with one or more user equipment connected to the apparatus that is to be offloaded. The apparatus may further be caused to receive the cost metric along with a list of the one or more user equipment associated with the cost metric. In addition, the apparatus may be caused to transmit a second request and the list of the one or more user equipment to a second network node for a predicted cost metric associated with the one or more user equipment in the list when connected to the second network node. Further, the apparatus may be caused to receive the predicted cost metric in response to the second request. The apparatus may also be caused to initiate offloading of the one or more user equipment in the list to the second or third network node based on whichever node has the lowest cost metric.

Other example embodiments may be directed to an apparatus. The apparatus may include means for determining a need for offloading at the apparatus. The apparatus may also include means for transmitting a first request to a first network node for a cost metric associated with one or more user equipment connected to the apparatus that is to be offloaded. The apparatus may further include means for receiving the cost metric along with a list of the one or more user equipment associated with the cost metric. In addition, the apparatus may include means for transmitting a second request and the list of the one or more user equipment to a second network node for a predicted cost metric associated with the one or more user equipment in the list when connected to the second network node. Further, the apparatus may include means for receiving the predicted cost metric in response to the second request. The apparatus may also include means for initiating offloading of the one or more user equipment in the list to the second or third network node based on whichever node has the lowest cost metric.

In accordance with other example embodiments, a non-transitory computer readable medium may be encoded with instructions that may, when executed in hardware, perform a method. The method may include determining, by a first network node, a need for offloading at the first network node. The method may also include transmitting a first request to a second network node for a cost metric associated with one or more user equipment connected to the first network node that is to be offloaded. The method may further include receiving the cost metric along with a list of the one or more user equipment associated with the cost metric. In addition, the method may include transmitting a second request and the list of the one or more user equipment to a third network node for a predicted cost metric associated with the one or more user equipment in the list when connected to the third network node. In addition, the method may include receiving the predicted cost metric in response to the second request. The method may also include initiating offloading of the one or more user equipment in the list to the second or third network node based on whichever node has the lowest cost metric.

Other example embodiments may be directed to a computer program product that performs a method. The method may include determining, by a first network node, a need for offloading at the first network node. The method may also include transmitting a first request to a second network node for a cost metric associated with one or more user equipment connected to the first network node that is to be offloaded. The method may further include receiving the cost metric along with a list of the one or more user equipment associated with the cost metric. In addition, the method may include transmitting a second request and the list of the one or more user equipment to a third network node for a predicted cost metric associated with the one or more user equipment in the list when connected to the third network node. In addition, the method may include receiving the predicted cost metric in response to the second request. The method may also include initiating offloading of the one or more user equipment in the list to the second or third network node based on whichever node has the lowest cost metric.

Other example embodiments may be directed to an apparatus that may include circuitry configured to determine a need for offloading at the apparatus. The apparatus may also include circuitry configured to transmit a first request to a first network node for a cost metric associated with one or more user equipment connected to the apparatus that is to be offloaded. The apparatus may further include circuitry configured to receive the cost metric along with a list of the one or more user equipment associated with the cost metric. In addition, the apparatus may include circuitry configured to transmit a second request and the list of the one or more user equipment to a second network node for a predicted cost metric associated with the one or more user equipment in the list when connected to the second network node. Further, the apparatus may include circuitry configured to receive the predicted cost metric in response to the second request. The apparatus may also include circuitry configured to initiate offloading of the one or more user equipment in the list to the second or third network node based on whichever node has the lowest cost metric.

Certain example embodiments may be directed to a method. The method may include receiving, at a second network node from a first network node a request and a list of one or more user equipment for a predicted cost metric associated with the one or more user equipment in the list when connected to the second network node. The method may also include checking a resource availability at the second network node for the one or more user equipment in the list. The method may further include transmitting a response to the request to the first network node, wherein the response includes the predicted cost metric associated with the one or more user equipment in the list. In addition, the method may include receiving, from the first network node, offloading of the one or more user equipment in the list.

Other example embodiments may be directed to an apparatus. The apparatus may include at least one processor and at least one memory including computer program code. The at least one memory and computer program code may be configured to, with the at least one processor, cause the apparatus at least to receive, from a first network node, a request and a list of one or more user equipment for a predicted cost metric associated with the one or more user equipment in the list when connected to the apparatus. The apparatus may also be caused to check a resource availability at the apparatus for the one or more user equipment in the list. The apparatus may further be caused to transmit a response to the request to the first network node, wherein the response may include the predicted cost metric associated with the one or more user equipment in the list. In addition, the apparatus may be caused to receive, from the first network node, offloading of the one or more user equipment in the list.

Other example embodiments may be directed to an apparatus. The apparatus may include means for receiving, from a first network node, a request and a list of one or more user equipment for a predicted cost metric associated with the one or more user equipment in the list when connected to the apparatus. The apparatus May also include means for checking a resource availability at the apparatus for the one or more user equipment in the list. The apparatus may further include means for transmitting a response to the request to the first network node, wherein the response includes the predicted cost metric associated with the one or more user equipment in the list. In addition, the apparatus include means for receiving, from the first network node, offloading of the one or more user equipment in the list.

In accordance with other example embodiments, a non-transitory computer readable medium may be encoded with instructions that may, when executed in hardware, perform a method. The method may include receiving, at a second network node from a first network node a request and a list of one or more user equipment for a predicted cost metric associated with the one or more user equipment in the list when connected to the second network node. The method may also include checking a resource availability at the second network node for the one or more user equipment in the list. The method may further include transmitting a response to the request to the first network node, wherein the response includes the predicted cost metric associated with the one or more user equipment in the list. In addition, the method may include receiving, from the first network node, offloading of the one or more user equipment in the list.

Other example embodiments may be directed to a computer program product that performs a method. The method may include receiving, at a second network node from a first network node a request and a list of one or more user equipment for a predicted cost metric associated with the one or more user equipment in the list when connected to the second network node. The method may also include checking a resource availability at the second network node for the one or more user equipment in the list. The method may further include transmitting a response to the request to the first network node, wherein the response includes the predicted cost metric associated with the one or more user equipment in the list. In addition, the method may include receiving, from the first network node, offloading of the one or more user equipment in the list.

Other example embodiments may be directed to an apparatus that may include circuitry configured to receive, from a first network node, a request and a list of one or more user equipment for a predicted cost metric associated with the one or more user equipment in the list when connected to the apparatus. The apparatus may also include circuitry configured to check a resource availability at the apparatus for the one or more user equipment in the list. The apparatus may further include circuitry configured to transmit a response to the request to the first network node, wherein the response includes the predicted cost metric associated with the one or more user equipment in the list. In addition, the apparatus may include circuitry configured to receive, from the first network node, offloading of the one or more user equipment in the list.

### BRIEF DESCRIPTION OF THE DRAWINGS

For proper understanding of example embodiments, reference should be made to the accompanying drawings, wherein:

FIG. 1 illustrates a an example functional framework for radio access network intelligence.

FIG. 2 illustrates an example signal flow diagram for offloading traffic between cells, according to certain example embodiments.

FIG. 3 illustrates an example offloading plan procedure, according to certain example embodiments.

FIG. 4 illustrates an example signal diagram of inter-distributed unit offloading, according to certain example embodiments.

FIG. 5 illustrates an example user equipment context group setup request message, according to certain example embodiments.

FIG. 6 illustrates an example flow diagram of a method, according to certain example embodiments.

FIG. 7 illustrates an example flow diagram of another method, according to certain example embodiments.

FIG. 8 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for offloading plan enabled exchange between network nodes. For instance, some example embodiments may be directed to offloading plan enabled artificial intelligence (AI) or machine learning (ML) use cases.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

According to the technical standards of the 3^{rd} Generation Partnership Project (3GPP), energy saving functionality has been introduced to reduce the network energy consumption and the energy-related operational expenses when possible. Energy saving deployments may consider capacity booster cells that are deployed on top of coverage cells to enhance capacity for Evolved Universal Mobile telecommunications System (UMTS) E-UTRA or NR in single or dual connectivity. Those cells are allowed to be optimized by being switched off when capacity is not needed and re-activated on demand. Switching off a cell may be done by the operations, administration, and maintenance (OAM) and by the next generation radio access network (NG-RAN) node owning the capacity cell which can autonomously switch it off using, for example, cell load information.

Offloading is a basic element/component in multiple AIML enabled use cases. For example, 3GPP Rel-17 has defined three use cases-energy saving, load balancing, and mobility optimization. All three of these use cases involve the offloading of one or more UE to one or more suitable cells to ensure that the overall performance objective is met. Though this document describes the idea in the context of energy saving, the concept may also be applicable in other use cases such as, for example, load balancing and mobility optimization.

An NG-RAN node can initiate handover to offload traffic from the cell being switched off (and a reason for this handover can be indicated to help the node in future actions). Neighbors may be informed over Xn by the owner of the cell about the switch off decision. Additionally, idle mode user equipment (UEs) may be prevented from camping on a cell that is switched off, and incoming handovers can be prevented as well. Neighbors can keep cell configuration data even when a cell is inactive. Further, an NG-RAN node not owning capacity booster cells, can request re-activation of a capacity cell from a neighbor over Xn if there is a capacity need. In this case, cell activation procedure may be used. Neighbors may also be informed over Xn about the switch on (re-activation) decision over the Xn interface, and switch on may also be decided by the OAM.

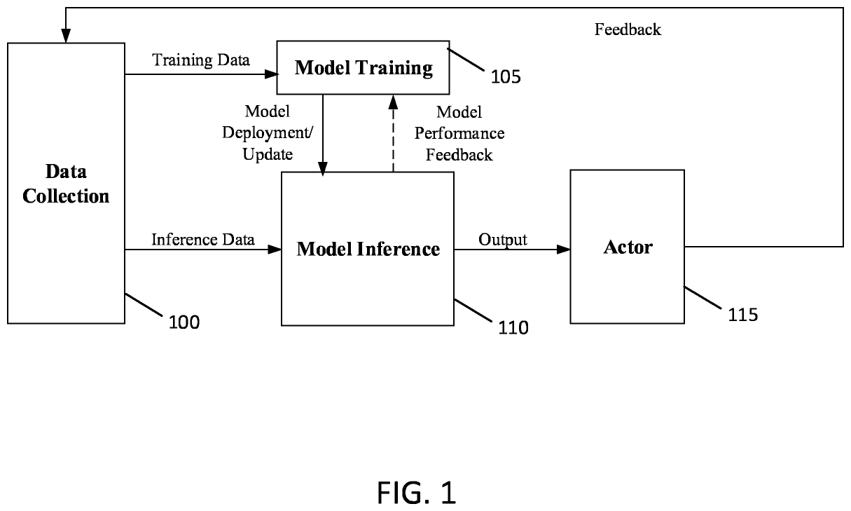

According to 3GPP, data needed by an AI function maybe identified in the input, and the data that is produced in the output. FIG. 1 illustrates an example AI/ML workflow. A purpose of the example AI/ML workflow is to identify the necessary (input) data to the AI/ML algorithm provided by data collection to be used for model training (training data), and model inference (inference data). Additionally, the output information as well as the actions that the actor will execute based on the outcome of the model inference may represent such data for collection and use in model training.

In particular, FIG. 1 illustrates an example functional framework for RAN intelligence. As illustrated in FIG. 1, the data collection 100 is a function that provides input to the model training 105 and model inference functions 110. AI/ML algorithm specific data preparation (e.g., pre-processing and cleaning, formatting, and transformation) may not be carried out in the data collection function 100. Examples of input data may include measurements from UEs or different network entities, feedback from an actor 115, and/or output from an AI/ML model. Additionally, the training data may include data needed as input for the AI/ML model training function, and the inference data may include data needed as input for the AI/ML model inference function.

As illustrated in FIG. 1, the model training function 105 may perform the AI/ML model training, validation, and testing which may generate model performance metrics as part of the model testing procedure. The model training function 105 may also be responsible for data preparation (e.g., data pre-processing and cleaning, formatting, and transformation) based on training data delivered by the data collection function 100, if required. From the model training function 105, model deployment/update may be performed to deploy a trained, validated, and tested AI/ML model to the model inference function 110, or to deliver an updated model to the model inference function 110.

The model inference function 110 may operate to provide AI/ML model inference output (e.g., predictions or decisions). Further, the model inference function 110 may provide model performance feedback to the model training function 105 when applicable. Additionally, the model inference function 110 may be responsible for data preparation (e.g., data pre-processing and cleaning, formatting, and transformation) based on inference data delivered by the data collection function 100, if required. In some instances, the model performance feedback may be used for monitoring the performance of the AI/ML model, when available.

Referring to FIG. 1, the actor 115 may be a function that receives the output from the model inference function 110, and triggers or performs corresponding actions. The actor 115 may also trigger actions directed to other entities or to itself. The feedback illustrated in FIG. 1 may correspond to information that may be needed to derive training data, inference data, or to monitor the performance of the AI/ML model and its impact to the network through updating of key performance indicators (KPIs) and performance counters.

In 5G, the handover procedure may include handover preparation and handover execution. In handover preparation, resources in the target node may be prepared. In the handover execution, handover command may be transmitted from the source node to the UE and the UE attaching to the target node. Conventional procedures are designed to consider the L3 mobility use case where the UE-specific (i.e., an individual UE) reports radio resource management (RRM) measurements to the network which trigger the handover preparation, execution, and context release procedures.

In some cases, it may be preferable if a source node prepares a handover to another neighbour cell over a set of UEs. This could help determine a cumulative effect of an AI/ML action to the network performance. In this case, instead of deciding handover actions based on individual UEs, an offloading plan may enable a source gNB to offload all UEs meeting certain criteria to a neighbor gNB. Those UEs may meet a priority in the offloading. The criteria may depend on a cost or reward/gain that the offloading action will incur to the involved nodes. In general, the objective is to reduce the “cost” or maximize the “reward/gain”. A given use case may focus on either of it. For example, in energy saving, the cost is the amount of additional throughout that the offloaded UE cause to the target node, while the reward/gain is the maximization of the energy efficiency for a given number of UEs that are served. Similarly, for load balancing use cases, the cost is the amount of UEs served by each cell, and the reward/gain is the maximization of aggregated cell throughput. In certain cases, only actions/offloading plans that incur a decrease in the cost should be selected by the source gNB. In this way, a gNB can guarantee that a cell can be switched off if all the UEs in the cell (belonging in one or more offloading plans) can be offloaded to another cell since this would be an offloading plan that minimizes the energy saving cost (by allowing the source node (capacity cell) to switch off).

Energy saving cost can be calculated in terms of the energy spent per transmitted load. Cost of an offloading action may depend on the optimization sought by the offloading plan. Other examples of cost may include the overall delay experienced by a set of offloaded UEs in the target gNB. This may avoid situations where a UE is offloaded to a gNB but a cell cannot be switched off if other UEs remain connected to it. In other examples, energy efficiency may be another metric that can be used. For instance, energy efficiency may be estimated using the data volume (amount of data transmitted), and the energy consumption. Alternatively, energy efficiency may also be calculated using coverage area and the energy consumption.

Minimizing a cost could be equivalent to maximizing a reward. Thus, the criteria could also depend on the corresponding reward that the offloading action will incur to the involved nodes. Similarly, only actions/offloading plans that incur an increase in the incurred reward should be selected by the source gNB. An example of such reward could be the amount of load transmitted for a given energy expenditure for a certain number of UEs. Reward of an offloading action may depend on the optimization sought by the offloading plan. Other examples of reward could be the overall achievable (sum) throughput of a set of UEs in the target gNB. Cost or rewards may be scaled according to the priority of the UEs participating the offloading plan. For example, the reward of a UE with a higher priority will have a higher multiplier compared to the reward from a UE with a lower priority. Another example of energy saving rewards may include maximizing the data volume or minimizing the energy consumption that can be considered as rewards. In the load balancing use case, maximizing the system performance (aggregated cell throughput) across all the load balanced cells may be considered as a reward. Further, if the cost is based on DU-related information ((predicted) throughout, (predicted data volume, (predicted) beam failure recovery (BFR), and/or (predicted) traffic), then a gNB-CU may need to obtain the cost from its DUs, through a new F1AP procedure.

However, even though there may be a need for an offloading plan, the current specifications do not provide any support to enable the offloading plan exchange between the source node and target node before executing a handover procedure needed for many use cases, including AI/ML energy saving and AI/ML load balancing. Thus, as described herein, certain example embodiments provide a mechanism for offloading plan preparation, and a mechanism to trigger an offloading plan exchange between multiple network nodes such as, for example, between a source node and a target node (e.g., between two centralized unit gNBs (gNB-CUs) or between two distributed unit gNBs (gNB-DUs)).

According to certain example embodiments, the mechanism for offloading plan preparation may take place within the source node such as, for example, within the gNB or gNB-CU. According to some example embodiments, the mechanism may be triggered when UE measurements have been collected at the source node to identify candidate target nodes for the offloading. According to other example embodiments, a mechanism to trigger an offloading plan exchange between the source node and the target node may be provided. For instance, in this mechanism, the source node may indicate to the target node a candidate offloading plan (e.g., number of UEs and optionally total resource needed), and request from a neighboring gNB to determine how expensive those UEs would be if offloaded to it. The mechanism to trigger the offloading plan may also include a mechanism for the source node to determine the optimal handover UE list that minimizes the cost (or that maximizes the gain/reward) of the offloading plan.

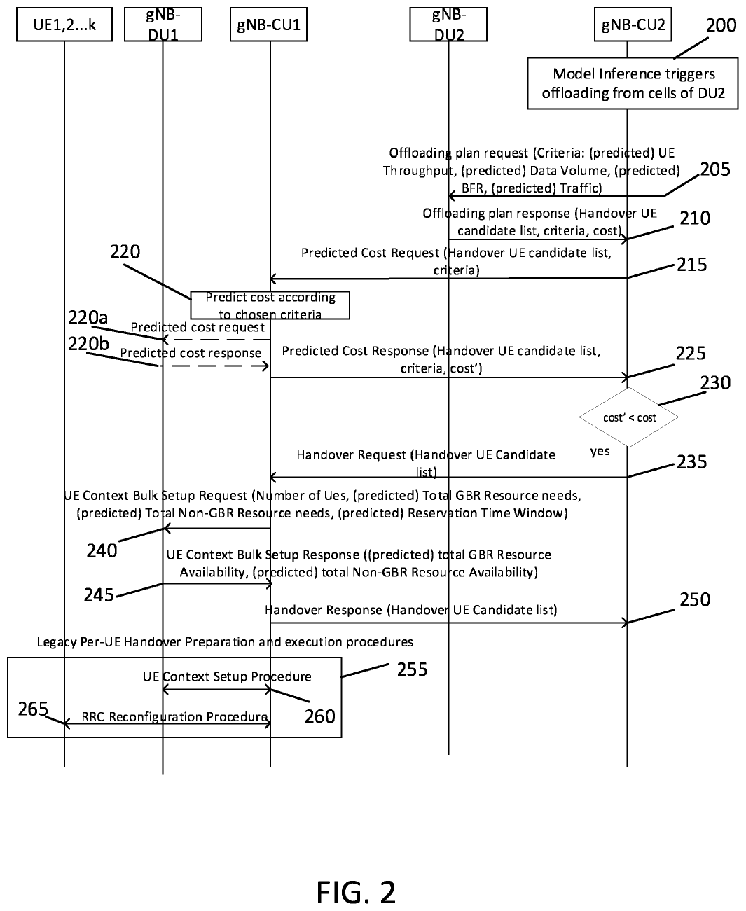

FIG. 2 illustrates an example signal flow diagram for offloading traffic between cells, according to certain example embodiments. For instance, as illustrated in FIG. 2, at 200, the model inference function may trigger offloading from the cells of gNB-CU2, where gNB-CU2 corresponds to a CU of a capacity cell entering energy saving mode. This may trigger the need to offload a number of UEs from gNB-CU2.

According to certain example embodiments, gNB-CU2 may determine how much a set of UEs connected to it cost. The cost may be determined according to a metric, which, in some cases, may depend on lower layers (e.g., it may be dependent upon throughput, BFR, predicted traffic, etc.). In certain example embodiments, at 205, gNB-CU2 may obtain the cost or the predicted cost through a request from the actual DU (where the UE is connected). It may also be possible that the cost is calculated internally by gNB-CU, in which case, it may calculate its cost without any need for signaling (e.g., if the cost is CU-based and can be calculated by the CU itself such as a number of radio resource control (RRC) connections, uplink (UL) cell packet data convergence protocol (PDCP) service data unit (SDU) data volume, etc.). According to certain example embodiments, the request may include criteria for determining the cost including, for example, as noted above, UE throughput, data volume, BFR, cell load, etc. At 210, gNB-DU2 may transmit an offloading plan response, which may include a handover UE candidate list including a list of UEs satisfying the criteria set forth in the request, and the determined cost.

As illustrated in FIG. 2, at 215, gNB-CU2 may request from a neighbor gNB-CU1, an expected (predicted) cost according to the same metric of the request transmitted at 205 that the identified set of UEs will incur if offloaded at the neighboring gNB (i.e., gNB-CU1). Upon receiving the request, gNB-CU1 may, at 220, calculate the predicted cost according to the criteria. At 225, gNB-CU1 may also return the predicted cost in a response back to gNB-CU2. Alternatively, in other example embodiments, at 220a, gNB-CU1 may transmit a predicted cost request to gNB-DU1 to determine the predicted cost. Additionally, at 220b, gNB-DU1 may transmit a response to gNB-CU1 including the predicted cost.

At 230, if the predicted cost is less than the cost that the UEs cost to the requesting node, then the latter may, at 235, initiate a handover of the offloading plan to the neighboring gNB-CU1. However, if the predicted cost is higher, then the requesting node may request another candidate gNB to obtain the expected cost of an offloading plan to it. The cost of an offloading plan to different neighbors may be considered, and the neighbor with the minimum cost (least cost) may be selected. Besides comparing two costs to determine whether one cost value is strictly less than another cost value, a threshold could be introduced to create a different way of cost comparison in terms of one cost value being threshold different (smaller or larger) than the other. If none of the neighbors is a good offloading candidate, then the requesting gNB may update the list of UEs in the offloading plan.

In response to the handover request transmitted by gNB-CU2, gNB-CU1 may at 240, transmit a UE context bulk setup request to gNB-DU1. According to certain example embodiments, the UE context bulk setup request may identify a number of UEs, (predicted) total guaranteed bit rate (GBR) resource needs, (predicted) total non-GBR resource needs, and/or a (predicted) reservation time window associated with the identified UEs. At 245, gNB-DU1 may transmit a response to the UE context bulk setup request, and include the (predicted) total GBR resource availability, and/or the (predicted) total non-GBR resource availability associated with the identified UEs. At 250, gNB-CU1 may transmit a response with the handover UE candidate list to gNB-CU2. At 255, legacy per-UE handover preparation and execution procedures for the candidate UEs may be executed including, at 260, UE context setup procedure between gNB-CU1 and gNB-DU1, and at 265, RRC reconfiguration procedure between gNB-CU1 and the UE(s).

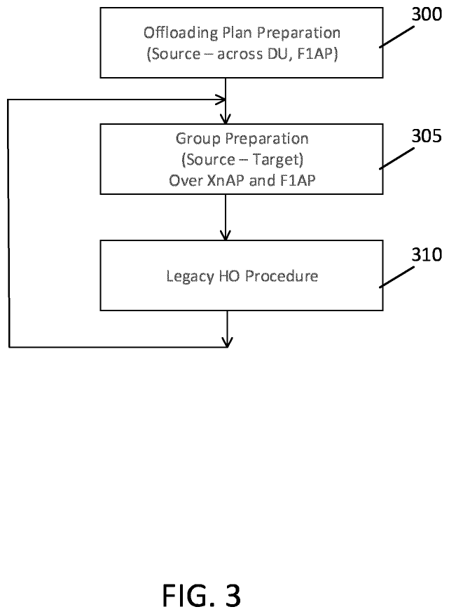

FIG. 3 illustrates an example offloading plan procedure, according to certain example embodiments. As illustrated in FIG. 3, the source node may at 300 and 305, prepare the offloading plan and group preparation. The source node may also iteratively perform the offloading plan exchange (in different levels of granularity) with one or more targets to finally achieve the offloading plan completion with the minimal cost according to a metric (i.e., cost metric). At 310, the legacy handover procedure of the candidate UEs may be performed.

As described above, offloading implementation may include a mechanism for offloading plan preparation, and a mechanism to trigger offloading plan exchange between nodes. The source node may decide that there is a need for an AI/ML action (e.g., related to AI/ML load balancing or AI/ML energy saving). Once this is decided, the source node may prepare an offloading plan. According to some example embodiments, this may involve a prediction of an expected cost that a set of UEs will incur to the gNB where they will be offloaded, and a comparison of this cost to the cost of those UEs in the current node. The source node may also perform a bulk resource reservation prediction (between two gNBs or two gNB-CUs over Xn interface or between a gNB-CU and a gNB-DU, over F1 interface), and finalize the candidate UE list and target cell. Once finalized, the source node may trigger a legacy handover procedure for the candidate cells.

In the offloading plan preparation (within the source node gNB or gNB-CU), the gNB may identify a set of UEs that are the most (or the least) expensive UEs for ML network operation. This may be evaluated through an (expected) cost (or reward/gain) metric, and may involve signaling between a gNB-CU and a gNB-DU in a split architecture. According to certain example embodiments, the UEs may be UEs contributing the most or least (cost) in the network energy consumption for a given load, or they are expected to contribute the most (cost) based on their movement towards the cell edge. Additionally, those UEs may be UEs that are lying at the cell boundary with very little load to transmit. Thus, the effective cost with respect to energy efficiency of these UEs may be very high. This would correspond alternatively that those UEs have a very small gain/reward with respect to energy efficiency.

In certain example embodiments, the identified UEs may be creating the most load, or they may be expected to create the most load compared to other UEs. Further, those UEs may include UEs whose load exceeds a threshold by D(x) Mbps of data of a UEx in a given cell. To be able to identify those UEs, the gNB-CU may transmit a request to its gNB-DUs to identify the N most expensive UEs according to a cost metric or the N best (least expensive) UEs according to a reward metric. As noted above, the cost or reward metric may be a (predicted) throughput, (predicted) delay, (predicted) data volume, (predicted) BFR, (predicted) traffic, (predicted) energy efficiency, (predicted) energy consumption, (predicted) load, etc. These metrics may relate to the UE identified as having the highest “cost”. In certain example embodiments, some of the above metrics correspond to a reward (e.g., an offloading action is selected containing UEs that would result in the highest predicted energy efficiency, etc.). In other example embodiments, some of those metrics correspond to a cost (e.g., an offloading action is selected containing UEs that will result in the lowest (predicted) delay, lowest (predicted) BFR, or lowest (predicted) energy consumption to give some examples). Together with the request, the gNB-CU may provide a threshold to the gNB-DU to allow the gNB-DU to return the N UEs whose cost exceeds the threshold. For instance, in certain example embodiments, if the threshold is set to D Mbps, then all UEs whose load is more than D may be characterized as the most expensive UEs for the network operation according to the load cost metric.

According to certain example embodiments, each gNB-DU may respond with a list of UEs corresponding to a handover candidate UE list, and may identify the UEs that are the most expensive according to the cost metric. In certain example embodiments, these identified UEs may represent the candidate UEs for offloading. The list may be an ordered list according to a priority with respect to the cost, namely the most expensive UEs are listed first. According to certain example embodiments, the cost may also be expressed with respect to the loss in performance of a set of UEs (e.g., due to a power ramp-down action at the gNB) so that the most impacted UEs are prioritized.

In certain example embodiments, the predicted cost may be related to an energy efficiency cost corresponding to the class of UEs. For instance, in some example embodiments, the energy efficiency cost may be the (predicted) energy efficiency at a gNB (source or target) corresponding to a given class of UEs. The energy efficiency may be lower for UEs at the cell edge that need a higher power to communicate a given amount of data. It can also be measured in terms of a loss in performance (e.g., throughput or delay, or number of radio link failures (RLFs) that a certain UE (or type of UE) experiences due to an energy saving decision (e.g., after a cell switches off).

According to certain example embodiments, the load balancing cost corresponding to the class of UEs may correspond to the (predicted) amount of traffic or (predicted) load at a gNB (source or target). In particular, the UEs with a lot of traffic may be classified as contributing more to the load balancing cost than other UEs.

As previously described, in certain example embodiments, the offloading plan may be exchanged in different levels of granularity. For instance, according to some example embodiments, one option of offloading plan granularity may include offloading plan with total resource needs. Here, the source node may prepare an offloading plan including, for example, a specific subset of UEs and total amount of resources needed at the target cell. Additionally, the source node may trigger a group preparation procedure to the target node. For instance, the group preparation procedure includes sending to the target node, the UE list, and the total GBR/non-GBR resource needs, and the duration for which the resources shall not be allocated for other purposes (L3 mobility, etc.). Furthermore, according to this option, the target node may send a response after checking the resource availability and the candidate list of UEs taking into account the throughput of the UEs in the list. The source node may also trigger UE-specific handover preparation and execution procedures upon receipt of the response from the target node, and after choosing the suitable target node.

As another option for offloading plan exchange in different levels of granularity, the offloading plan may be performed at a resource group level. For instance, according to certain example embodiments, the source node may analyze the offloading plan based on the resource usage and categorize UEs into groups by the resource needs of the UEs. For instance, the resource needs may be with respect to the UEs' need of GBR resources, and/or UEs with non-GBR resources. In some example embodiments, the groups may be categorized by group 1 (UE list, GBR-5 Mps), Group 2 (UE list, GBR-10 Mbps), Group 3 (UE list, Non-GBR), etc. Once categorized, the source node may transmit the categorized UE group(s) to the target node, after which the target node may check the resource availability per group and the candidate list of UEs taking into account the throughput of the UEs. In some example embodiments, categorization of the UE list itself may be optional. The target node may then send a response to the source node of the result(s) of the target node's checking of the resource availability per group and the candidate list of UEs. Once the source node receives the response from the target node, the source node may trigger a UE-specific handover preparation and execution procedure of the candidate UEs in the list (performed after choosing the suitable target node).

According to certain example embodiments, the offloading plan exchange may occur between the source node and the target node. Here, the source node may identify a need for offloading some or all the UEs to the target node due to, for example, AI/ML energy saving or AI/ML load balancing use cases. This may be done by the gNB requesting from a neighbor gNB to determine an expected cost the UE's will incur to the target node if those UEs were offloaded to a neighboring gNB. The cost may be evaluated based on the same metric that those UEs were evaluated. In certain example embodiments, a gNB-CU may also request from another gNB-DU the expected cost of the offloading to determine the best gNB-DU in case of inter-DU offloading. The request may optionally or additionally include the option to provide the expected cost assuming that only the “epsilon” cost will incur at the target node (e.g., by the amount by which the cost exceeds the threshold). In certain example embodiments, the “epsilon” cost that will incur at the target may cover the case where the cost at the target node is slightly higher than the threshold. In this option, gNB-DU may be able to report this also as an optional or additional feature.

Upon receiving the request, the target node may perform additional inference on use-case specific AI/ML models to ensure if the group preparation can be accepted. With the additional inference, the target node may perform inference from other AI/ML models such as cell load prediction. This may be useful in deciding whether a node can accept the offloading plan. In other example embodiments, whether the group preparation can be accepted may refer to if the offloading plan can be accepted. Additionally, the group preparation may be applicable to any granularity of the offloading plan. In certain example embodiments, the inference data may refer to received load balancing handover resource reservation. The target node may also trigger mobility, load balancing, or energy saving (ES) handover inference. In performing these functions, it may be possible to check the predicted load due to other reasons such as load balancing or energy saving. Such a prediction may be needed before deciding whether the load due to the offloading plan can be accepted. Additionally, the target node may determine whether load balancing handover resource reservation requests can be accepted considering the predicted mobility and ES handover.

According to certain example embodiments, if for one or more UEs, a neighboring gNB (e.g., gNB-CU) responds with an expected/predicted cost that is less than the current cost, then the gNB may add this UE (and possibly other UEs) to the offloading plan for the given neighbor gNB. The source gNB (e.g., gNB-CU) may initiate the offloading of the identified UE(s) to a target gNB (e.g., gNB-CU) in case of inter-CU offloading. However, in other example embodiments, the source gNB-CU may initiate the offloading of the identified UE(s) to another gNB-DU in case of inter-DU offloading. In this case, the request (i.e., offloading request) may also indicate from the recipient node, the amount of offloaded traffic that needs to be offloaded (D(x)).

In certain example embodiments, there may be certain procedures that are needed to enable end-to-end Group level preparation (including the resource reservation at the DUs) of the corresponding target cells) before executing the UE-level handover execution procedures. For instance, the procedures may include F1AP corresponding to offloading plan procedure (CU-requested or DU-triggered); XnAP corresponding to group handover request procedure, and F1AP corresponding to group context setup procedure. According to certain example embodiments, the group level resource preparation may enable the CU to create a group (i.e., list of UEs) to the target cell depending on a resource status availability prediction (i.e., the resource status availability at the target cell).

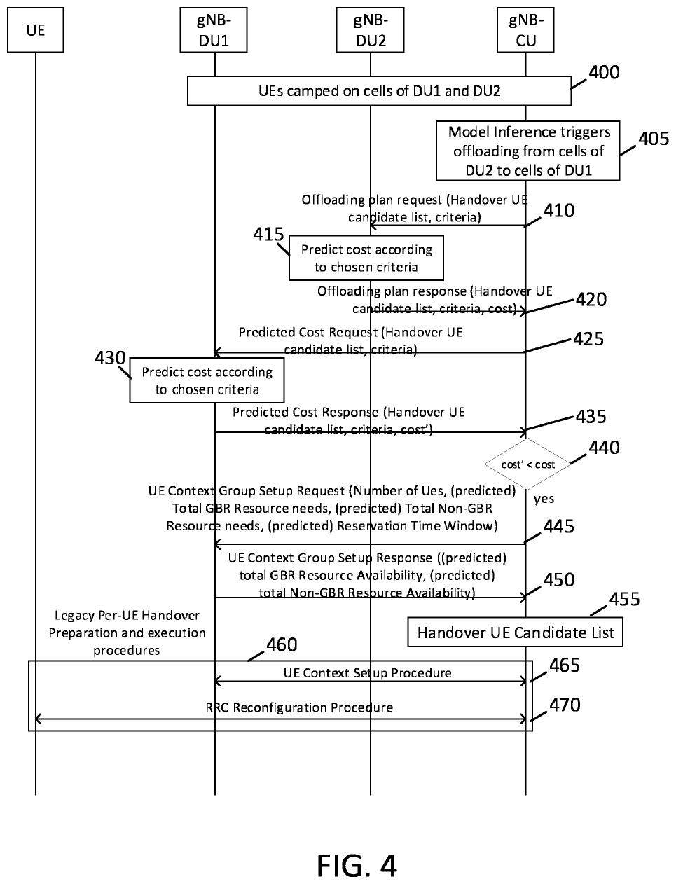

FIG. 4 illustrates an example signal diagram of inter-DU offloading, according to certain example embodiments. In case of intra-CU offloading, a gNB-CU may be able to determine how much cost a set of UEs cost to a given DU to which they are connected. The gNB-CU can either obtain cost information predicted by the gNB-DUs or it can obtain measurement information corresponding to cost and perform the prediction itself.

At 400, UEs may be camped on the cells of gNB-DU1 and gNB-DU2. At 405, the model inference function may trigger offloading from the cells of DU2 to the cells of DU1. At 410, gNB-CU may transmit an offloading plan request to gNB-DU2, and the request may include a handover UE candidate list (list of UEs with the highest cost) along with criteria for handover of each of the UEs in the list. At 415, gNB-DU2 may predict a cost metric according to the chosen criteria contained in the request from gNB-CU. At 420, gNB-DU2 may transmit an offloading plan response including the predicted cost to gNB-CU, and include in the response, a list of handover candidate UEs that satisfy the criteria set by gNB-CU. At 425, gNB-CU may send another predicted cost request to gNB-DU1, which may also include a handover UE candidate list (list of UEs with the highest cost) along with criteria for handover of each of the UEs in the list. At 430, gNB-DU1 may predict a cost metric according to the chosen criteria contained in the second request from gNB-CU. At 435, gNB-DU1 may transmit the predicted cost to gNB-CU, and include in the response, a list of handover candidate UEs that satisfy the criteria set by gNB-CU.

At 440, gNB-CU may determine if the predicted cost from gNB-DU1 is less than the predicted cost from gNB-DU2. At 445, if the predicted cost from gNB-DU1 is less than the predicted cost from gNB-DU2, gNB-CU may initiate handover of the offloading plan to gNB-DU1. In certain example embodiments, the cost comparison may also be with respect to a threshold namely to compare whether the predicted cost from gNB-DU1 is by threshold less than the predicted cost from gNB-DU2. In certain example embodiments, this may be done by transmitting a UE context group setup request to gNB-DU1, which may include the number of UEs, total GBR resource needs, total non-GBR resource needs, and/or reservation time window of each of the UEs. In some example embodiments, the total GBR resource needs, total non-GBR resource needs, and reservation time window may all be predicted values. At 450, gNB-DU1 may transmit a UE context group setup response in response to the request from gNB-CU. The UE context group setup response may include the (predicted) total GBR resource availability, and/or (predicted) total non-GBR resource availability at gNB-DU1. At 455, gNB-CU may prepare the handover UE candidate list. In other example embodiments, with the UE candidate list, the gNB-CU may perform an offloading plan exchange and target node selection, an offloading plan preparation, and a legacy handover. Operation 455 may represent the final step of executing the legacy handover procedure with a chosen target for a given offloading plan (set of UEs). At 460, legacy handover preparation and execution procedures may be initiated per-UE. As illustrated in FIG. 4, the legacy per-UE handover preparation and execution procedures may include at 465, a UE context setup procedure between gNB-CU and gNB-DU1, and at 470, an RRC reconfiguration procedure between gNB-CU and the UE. In certain example embodiments, the UE may correspond to one of the UEs for which the legacy handover procedure is performed.

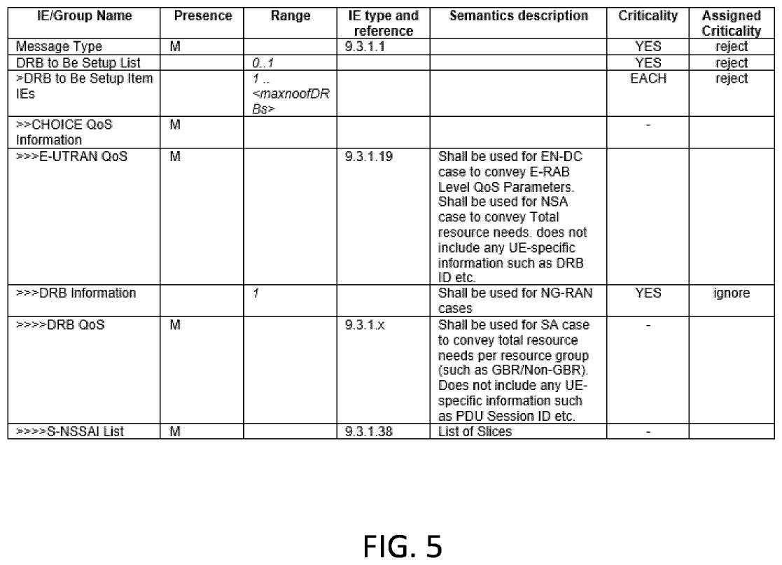

FIG. 5 illustrates an example UE context group setup request message, according to certain example embodiments. In particular, the example message of FIG. 5 relates to a UE context group setup request sent by the gNB-CU to the gNB-DU to enable group preparation. The table in FIG. 5 proposes a F1AP signaling message between gNB-CU and gNB-DU, which may be used to convey the total resource needs corresponding to an offloading plan.

According to certain example embodiments, the AI/ML model may be trained to maximize the spectral efficiency for UEs and energy efficiency for cell(s), or to minimize the load of a given cell subject to UE performance constraints and minimize the energy consumption of cells. In some example embodiments, the AI/ML model may identify specific UE distribution patterns that can result in sub-optimal spectral efficiency and the reasons for the sub-optimal spectral efficiency (cell edge, etc.). Additionally, the AI/ML model may predict the specific UE distribution patterns that can result in sub-optimal energy efficiency and the reasons for the sub-optimal energy efficiency (more UEs at cell edge, etc.). In certain example embodiments, the AI/ML may have the ability to infer the effective UE distribution which cause the UE level spectral efficiency and cell level energy efficiency to maximize. The AI/ML may also have the ability to infer the candidates for the handover, and monitor model performance by observing the UE level spectral efficiency and cell level energy efficiency.

In certain example embodiments, for model training of the AI/ML model, criteria for “most expensive” UE may include expected energy consumption or expected energy efficiency at the target, expected load at the target, spectral efficiency (i.e., a measure of a number of bits/second/Hz), and loss in performance due to an action (e.g., energy saving). In other example embodiments, for model training of the AI/ML model, the cell level energy efficiency PM counters may include the average number of RRC connected UEs, UE distribution in the cell coverage (cell center/cell edge), cell power, UE throughput PM counters, and UL PDCP SDU data volume measurements. Other targeted data collection for training and inference phases may include UE RRM measurements and resource status of neighbor cells.

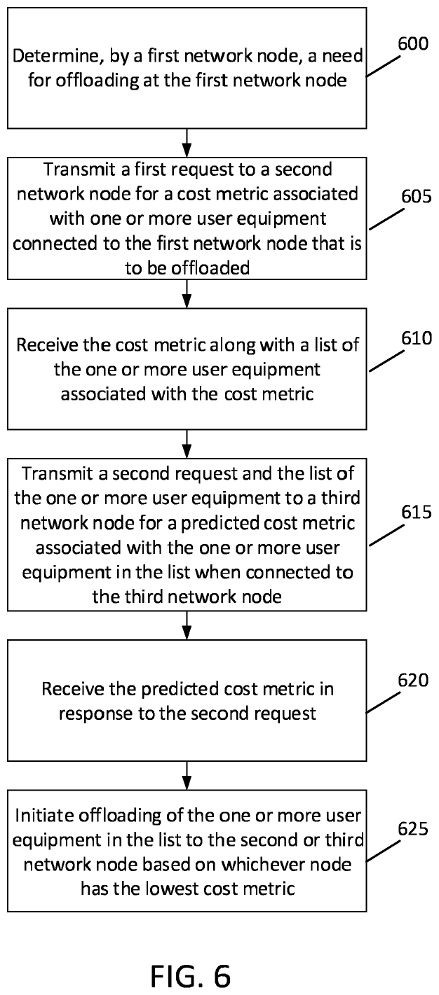

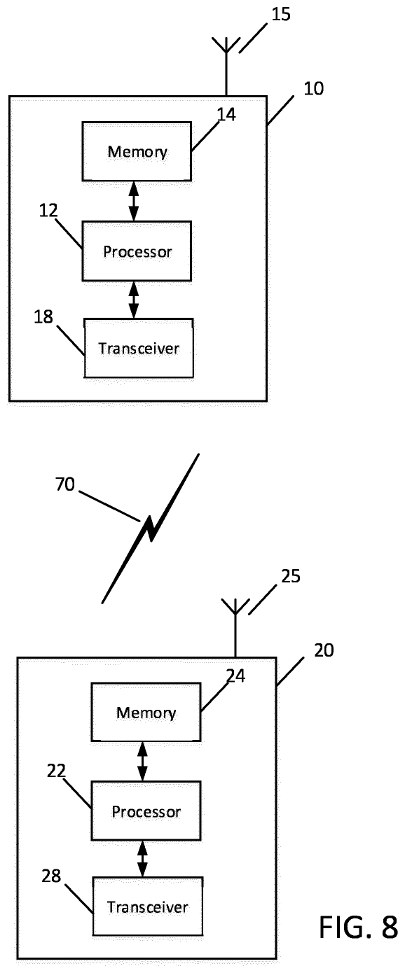

FIG. 6 illustrates an example flow diagram of a method, according to certain example embodiments. In an example embodiment, the method of FIG. 6 may be performed by a network entity, or a group of multiple network elements in a 3GPP system, such as LTE or 5G-NR. For instance, in an example embodiment, the method of FIG. 6 may be performed by a network, network node, gNB, or device similar to one of apparatuses 10 or 20 illustrated in FIG. 8.

According to certain example embodiments, the method of FIG. 6 may include, at 600, determining, by a first network node, a need for offloading at the first network node. In certain example embodiments, the mobility optimization may include offloading one or more UEs triggered by one of the AIML enabled use cases (e.g., network energy saving, load balancing, and mobility optimization). At 605, the method may include transmitting a first request to a second network node for a cost metric associated with one or more user equipment connected to the first network node that is to be offloaded. Further, at 610, the method may include receiving the cost metric along with a list of the one or more user equipment associated with the cost metric, In addition, at 615, the method may include transmitting a second request and the list of the one or more user equipment to a third network node for a predicted cost metric associated with the one or more user equipment in the list when connected to the third network node. However, in other example embodiments, the offloading request may be triggered in parallel. For instance, in one example embodiment, after receiving a response from all the nodes, the first network node may make the selection of UEs to be offloaded. At 620, the method may also include receiving the predicted cost metric in response to the second request. Additionally, at 625, the method may include initiating offloading of the one or more user equipment in the list to the second or third network node based on whichever node has the lowest cost metric.

According to certain example embodiments, the cost metric may correspond to at least one of a throughput value, a data volume, or a beam failure recovery metric associated with one or more user equipment in the list, or to a reward corresponding to at least one of a data volume, energy efficiency, or a traffic load at a cell level. According to some example embodiments, the first request may be transmitted together with a threshold value related to the cost metric. According to other example embodiments, the list may be an ordered list according to a priority with respect to the cost metric of each of the one or more user equipment.

In certain example embodiments, the offloading may include a subset of the one or more user equipment and a total amount of resources needed at the second network node, or categories of the one or more user equipment, wherein each of the categories is separated based on resource usage, and resource needs of the one or more user equipment including user equipment based on resource categories such as guaranteed bit rate resources or user equipment with non-guaranteed bit rate resources. In some when the predicted cost metric is greater than the cost metric, the method may further include requesting a fourth network node for an expected cost of offloading to the fourth network node. In other example embodiments, the method may further include updating the list of the one or more user equipment when there is not an acceptable offloading candidate network node for the one or more user equipment.

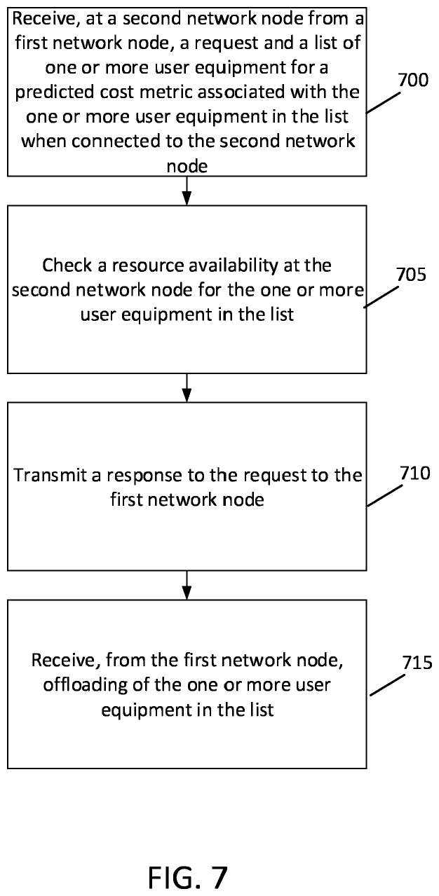

FIG. 7 illustrates an example of a flow diagram of another method, according to certain example embodiments. In an example embodiment, the method of FIG. 7 may be performed by a network entity, or a group of multiple network elements in a 3GPP system, such as LTE or 5G-NR. For instance, in an example embodiment, the method of FIG. 7 may be performed by a network, network node, or gNB similar to one of apparatuses 10 or 20 illustrated in FIG. 8.

According to certain example embodiments, the method of FIG. 7 may include, at 700, receiving, at a second network node from a first network node a request and a list of one or more user equipment for a predicted cost metric associated with the one or more user equipment in the list when connected to the second network node. At 705, the method may include checking a resource availability at the second network node for the one or more user equipment in the list. Further, at 710, the method may include transmitting a response to the request to the first network node. In certain example embodiments, the response may include the predicted cost metric associated with the one or more user equipment in the list. At 715, the method may include receiving, from the first network node, offloading of the one or more user equipment in the list.

According to certain example embodiments, the predicted cost metric corresponds to at least one of a throughput value, a data volume, or a beam failure recovery metric associated with one or more user equipment in the list, or to a reward corresponding to at least one of a data volume, energy efficiency, or a traffic load at a cell level. According to some example embodiments, the list may be an ordered list according to a priority with respect to the cost metric of each of the one or more user equipment. According to other example embodiments, the offloading may include a subset the one or more user equipment and a total amount of resources needed at the second network node, or categories of the one or more user equipment, wherein each of the categories is separated based on resource usage, and resource needs of the one or more user equipment comprising user equipment with guaranteed bit rate resources or user equipment with non-guaranteed bit rate resources.

FIG. 8 illustrates a set of apparatus 10 and 20 according to certain example embodiments. In certain example embodiments, the apparatus 10 may be a node or element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 8.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 8.

As illustrated in the example of FIG. 8, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 8, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-5.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-5.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

As illustrated in the example of FIG. 8, apparatus 20 may be a network, core network element, or element in a communications network or associated with such a network or network node, such as a gNB. It should be noted that one of ordinary skill in the art would understand that apparatus 20 may include components or features not shown in FIG. 8.

As illustrated in the example of FIG. 8, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 8, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-7.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1-7.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to determine a need for offloading at the apparatus. Apparatus 20 may also be controlled by memory 24 and processor 22 to transmit a first request to a first network node for a cost metric associated with one or more user equipment connected to the apparatus that is to be offloaded. Apparatus 20 may further be controlled by memory 24 and processor 22 to receive the cost metric along with a list of the one or more user equipment associated with the cost metric. Apparatus 20 may also be controlled by memory 24 and processor 22 to transmit a second request and the list of the one or more user equipment to a second network node for a predicted cost metric associated with the one or more user equipment in the list when connected to the second network node. Further, apparatus 20 may be controlled by memory 24 and processor 22 to receive the predicted cost metric in response to the second request. In addition, apparatus 20 may be controlled by memory 24 and processor 22 to initiate offloading of the one or more user equipment in the list to the second or third network node based on whichever node has the lowest cost metric.

In other example embodiments, apparatus 20 may be controlled by memory 24 and processor 22 to receive, from a first network node, a request and a list of one or more user equipment for a predicted cost metric associated with the one or more user equipment in the list when connected to the apparatus. Apparatus 20 may also be controlled by memory 24 and processor 22 to check a resource availability at the apparatus for the one or more user equipment in the list. Apparatus 20 may further be controlled by memory 24 and processor 22 to transmit a response to the request to the first network node. According to certain example embodiments, the response may include the predicted cost metric associated with the one or more user equipment in the list. Apparatus 20 may further be controlled by memory 24 and processor 22 to receive, from the first network node, offloading of the one or more user equipment in the list.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for determining a need for offloading at the apparatus. The apparatus may also include means for transmitting a first request to a first network node for a cost metric associated with one or more user equipment connected to the apparatus that is to be offloaded. The apparatus may further include means for transmitting a second request and the list of the one or more user equipment to a second network node for a predicted cost metric associated with the one or more user equipment in the list when connected to the second network node. In addition, the apparatus may include means for receiving the predicted cost metric in response to the second request. Further, the apparatus may include means for initiating offloading of the one or more user equipment in the list to the second or third network node based on whichever node has the lowest cost metric.

Certain example embodiments may also be directed to an apparatus that includes means for receiving from a first network node a request and a list of one or more user equipment for a predicted cost metric associated with the one or more user equipment in the list when connected to the apparatus. The apparatus may also include means for checking a resource availability at the second network node for the one or more user equipment in the list. The apparatus may further include means for transmitting a response to the request to the first network node. According to certain example embodiments, the response may include the predicted cost metric associated with the one or more user equipment in the list. In addition, the apparatus may include means for receiving, from the first network node, offloading of the one or more user equipment in the list.

Certain example embodiments described herein provide several technical improvements, enhancements, and/or advantages. For instance, in some example embodiments, the AIML model may maximize the spectral efficiency for UEs and energy efficiency for cell(s), or minimize the load of a given cell subject to UE performance constraints. In other example embodiments, the AIML model may identify specific UE distribution patterns that can result in sub-optimal spectral efficiency and the reasons (cell edge, etc.). Additionally, in some example embodiments, the AIML model may predict the specific UE distribution patterns that can result in sub-optimal energy efficiency and the reasons (e.g., more UEs at cell edge, etc.).

Certain example embodiments may also simplify the specification and the gNB and UE operation. For instance, with certain example embodiments, the gNB and the UE do not need to calculate all possible DCI sizes (over all possible scheduling combinations) before decoding the DCI based on the latest status of the schedulable DL (or UL) serving cells as the DCI size is fixed. Additionally, since the DCI size does not vary, the gNB DL control scheduler implementation and operation may be simplified.

According to further example embodiments, it may be possible to allow the gNB, depending on the current number of required cell-specific DCI bits for each of the scheduled cells, to schedule a larger or smaller number of cells. Additionally, certain example embodiments may allow the gNB to trade-off cell specific scheduling flexibility (in terms of common/cell-specific DCI fields, and the number of scheduled cells), and at the same time having full control over the related DCI size and related required number of DL control resources and related DCI decoding reliability.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

Partial Glossary:

| | |
|---|---|
| 3GPP | 3rd Generation Partnership Project |
| 5G | 5th Generation |
| 5GCN | 5G Core Network |
| 5GS | 5G System |
| BFR | Beam Failure Recovery |
| BS | Base Station |
| CU | Centralized Unit |
| DL | Downlink |
| DU | Distributed Unit |
| gNB | 5G or Next Generation NodeB |
| HO | Handover |
| LTE | Long Term Evolution |
| NR | New Radio |
| RAN | Radio Access Network |
| RRC | Radio Resource Control |
| UE | User Equipment |
| UL | Uplink |

1.-34. (canceled)

35. A method, comprising:
determining, by a first network node, a need for offloading at the first network node;
transmitting a first request to a second network node for a cost metric associated with one or more user equipment connected to the first network node that is to be offloaded;
receiving the cost metric along with a list of the one or more user equipment associated with the cost metric;
transmitting a second request and the list of the one or more user equipment to a third network node for a predicted cost metric associated with the one or more user equipment in the list when connected to the third network node;
receiving the predicted cost metric in response to the second request; and
initiating offloading of the one or more user equipment in the list to the second or third network node based on whichever node has the lowest cost metric.

36. The method according to claim 35, wherein the cost metric corresponds to at least one of a throughput value, a data volume, or a beam failure recovery metric associated with one or more user equipment in the list, or
wherein the cost metric corresponds to a reward corresponding to at least one of a data volume, energy efficiency, or a traffic load at a cell level.

37. The method according to claim 35, wherein the first request is transmitted together with a threshold value related to the cost metric.

38. The method according to claim 35, wherein the list is an ordered list according to a priority with respect to the cost metric of each of the one or more user equipment.

39. The method according to claim 35, wherein the offloading comprises:
a subset of the one or more user equipment and a total amount of resources needed at the second network node, or
categories of the one or more user equipment, wherein each of the categories is separated based on resource usage, and resource needs of the one or more user equipment comprising user equipment based on resource categories such as guaranteed bit rate resources or user equipment with non-guaranteed bit rate resources.

40. The method according to claim 35, when the predicted cost metric is greater than the cost metric, the method further comprises:
requesting a fourth network node for an expected cost of offloading to the fourth network node.

41. The method according to claim 35, further comprising:
updating the list of the one or more user equipment when there is not an acceptable offloading candidate network node for the one or more user equipment.

42. An apparatus, comprising:
at least one processor; and
at least one memory comprising computer program code,
the at least one memory and the computer program code configured to, with the at least one processor, cause the apparatus at least to perform:
determining a need for offloading at the apparatus;
transmitting a first request to a first network node for a cost metric associated with one or more user equipment connected to the apparatus that is to be offloaded;
receiving the cost metric along with a list of the one or more user equipment associated with the cost metric;
transmitting a second request and the list of the one or more user equipment to a second network node for a predicted cost metric associated with the one or more user equipment in the list when connected to the second network node;
receiving the predicted cost metric in response to the second request; and
initiating offloading of the one or more user equipment in the list to the second or third network node based on whichever node has the lowest cost metric.

43. The apparatus according to claim 42, wherein the cost metric corresponds to at least one of a throughput value, a data volume, or a beam failure recovery metric associated with one or more user equipment in the list, or
wherein the cost metric corresponds to a reward corresponding to at least one of a data volume, energy efficiency, or a traffic load at a cell level.

44. The apparatus according to claim 42, wherein the first request is transmitted together with a threshold value related to the cost metric.

45. The apparatus according to claim 42, wherein the list is an ordered list according to a priority with respect to the cost metric of each of the one or more user equipment.

46. The apparatus according to claim 42, wherein the offloading comprises:
a subset of the one or more user equipment and a total amount of resources needed at the second network node, or
categories of the one or more user equipment, wherein each of the categories is separated based on resource usage, and resource needs of the one or more user equipment comprising user equipment based on resource categories such as guaranteed bit rate resources or user equipment with non-guaranteed bit rate resources.

47. The apparatus according to claim 42, when the predicted cost metric is greater than the cost metric, the at least one memory and the computer program code are further configured to, with storing instructions that, when executed by the at least one processor, to cause the apparatus at least to perform:
requesting a third network node for an expected cost of offloading to the third network node.

48. The apparatus according to claim 42, wherein the at least one memory and the computer program code are further configured to, with storing instructions that, when executed by the at least one processor, to cause the apparatus at least to perform:
updating the list of the one or more user equipment when there is not an acceptable offloading candidate network node for the one or more user equipment.

49. An apparatus, comprising:
at least one processor; and
at least one memory comprising computer program code,
the at least one memory and the computer program code configured to, with the at least one processor, cause the apparatus at least to perform:
receiving, from a first network node, a request and a list of one or more user equipment for a predicted cost metric associated with the one or more user equipment in the list when connected to the apparatus;
checking a resource availability at the apparatus for the one or more user equipment in the list;
transmitting a response to the request to the first network node, wherein the response comprises the predicted cost metric associated with the one or more user equipment in the list; and
receiving, from the first network node, offloading of the one or more user equipment in the list.

50. The apparatus according to claim 49, wherein the predicted cost metric corresponds to at least one of a throughput value, a data volume, or a beam failure recovery metric associated with one or more user equipment in the list, or
wherein the cost metric corresponds to a reward corresponding to at least one of a data volume, energy efficiency, or a traffic load at a cell level.

51. The apparatus according to claim 49, wherein the list is an ordered list according to a priority with respect to the cost metric of each of the one or more user equipment.

52. The apparatus according to claim 49, wherein the offloading comprises:
a subset the one or more user equipment and a total amount of resources needed at the apparatus, or
categories of the one or more user equipment, wherein each of the categories is separated based on resource usage, and resource needs of the one or more user equipment comprising user equipment with guaranteed bit rate resources or user equipment with non-guaranteed bit rate resources.
